(19) United States
(12) Patent Application Publication
(10) Pub. No.: US 2011/0171526 A1
(43) Pub. Date: Jul. 14, 2011

(54) BINDER COMPOSITION FOR SECONDARY BATTERY ELECTRODE AND METHOD FOR PRODUCING SAME

(76) Inventors: Yasuhiro Wakizaka, Yokohama-city (JP); Yosuke Yabuuchi, Yokohama-city (JP)

(21) Appl. No.: 13/119,681

(22) PCT Filed: Sep. 17, 2009
(86) PCT No.: PCT/JP2009/066260

§ 371 Date: Mar. 17, 2011

(30) Foreign Application Priority Data
Sep. 18, 2008 (JP) 2008-239104

(51) Int. Cl. H01M 4/64; H01M 4/62; C08L 55/02

(52) U.S. Cl. 429/217; 252/182.1; 524/525

(57) ABSTRACT

A binder composition for secondary batteries having excellent stability over time is produced. A method for producing a binder composition for secondary batteries containing at least a polymer and a dispersion medium, which comprises a metal particulate removal step wherein metal particulates contained in a polymer dispersion containing a polymer and a dispersion medium are removed. A binder composition for secondary batteries, which is obtained by the above-mentioned production method and has a metal particulate content of not more than 10 ppm, said metal particulate content is composed of particles formed from a transition metal component and having a particle diameter of not less than 20 μm. A slurry for secondary battery electrodes, which contains the binder composition for secondary batteries and an electrode active material. A secondary battery electrode wherein an electrode active material layer containing the binder composition for secondary batteries and a positive electrode active material or a negative electrode active material is adhered to a collector. A secondary battery comprising the secondary battery electrode.

### TECHNICAL FIELD

The present invention relates to a binder composition for a secondary battery and a method of producing the same, a slurry for the secondary battery, an electrode for the secondary battery, and the secondary battery.

### BACKGROUND ART

The laptop computers, the portable terminals such as the cell phone are increasingly spread, and along with that a lithium ion secondary battery is used widely as the electrical power source of the portable terminals. In order to further improve the convenience, the development for the higher performance of the lithium ion secondary battery is carried out, and also the electrodes, the electrolyte solution, the active material, and the binder which are the battery constitution material show significant technical improvement.

The electrodes used for the lithium ion secondary battery is usually obtained by making the slurry by dispersing the electrode active material such as the positive electrode active material and the negative electrode active material, and the conductive agent which is added if needed, to various dispersion medium, and pasting thereof to the current collector, then by drying. At this time, in order to increase the binding property of each electrode active material and the electrode active material with the current collector, the binder composition including the binder for the secondary battery (hereinafter referred to as the binder) mainly comprising the macromolecule are mixed (for example, patent document 1) when forming the slurry.

Said binder has important role which allows exhibiting the characteristic of the lithium ion secondary battery, and the performance of the lithium ion secondary battery heavily changes depending on the status of the binder. Thus, in order to stably produce the lithium ion secondary battery with high performances, the binder composition is required to have high stability over time.

### Prior Art Document

Patent document 1: U.S. Pat. No. 7,316,864

### SUMMARY OF THE INVENTION

### Technical Problems to be Solved by the Invention

However, in the conventional method, the stability over time of the binder composition for the secondary battery was not sufficient, and it became viscous or precipitated over the time, hence it was difficult to stably produce the slurry for the secondary battery having the constant performances. Also, if the performances of the slurry for the secondary battery become unstable, then the coated thickness after coating the slurry for the secondary battery to the current collector becomes uneven. As a result, the characteristic balance of the obtained electrodes (the positive electrode or the negative electrode) is deteriorated, and the quality and the lifetime of the battery varies on each product; thus it was difficult to obtain the battery having the constant quality.

Therefore, the present invention aims to produce the binder composition for the secondary battery having good stability over time.

### Means for Solving the Technical Problems

Generally, as said binder composition, the dispersion in which the polymer is dispersed in the water, or the dispersion in which the polymer is dispersed or dissolved in the organic solvent are used.

Thus, the present inventors have tried out the common method to improve the stability over time of the dispersion (the aqueous polymer particle dispersion) dispersing the polymer in the water, wherein a charge protection layer such as an anion activator absorbing layer or the carboxyl group binding layer or so are provided as the protective layer of the polymer surface; or a hydrated protection layer such as a nonion activator absorbing layer, an aqueous polymer absorbing layer or an aqueous polymer binding layer or so are provided similarly. However, none of those had an effect.

Thus, the present inventors have found, as a result of keen examination, that the particulate metal component are included in the binder composition, and by reducing these, the stability over time can be significantly improved. When the particulate metal component is present in the binder composition, it elutes as a metal ion into the binder composition. Then, the eluted metal ion forms a metal ion crosslink between the polymers in the binder composition thereby increased the viscosity over the time. Also, the particulate metal component comes from the stainless (alloy of Fe, Cr, Ni) used in the plumbing or so, and by particularly focusing on these to reduce the particulate metals, the present inventors has found that further superior effect can be obtained. The present invention was accomplished based on these knowledge.

That is, the present invention solving the above problems include the followings as the subject.

(1) A method of production of a binder composition for a secondary battery comprising a polymer and a dispersing medium; wherein said method of production includes a step of removing a particulate metal component included in a polymer dispersion including the polymer and the dispersion medium.

(2) The method of production of the binder composition as set forth in (1), wherein said step of removing the particulate metal component is carried out by a magnetic force.

(3) A binder composition for the secondary battery obtained by the method of production as set forth in (1) or (2), wherein the content of the particulate metal component having the particle diameter of 20 μm or more is 10 ppm or less.

(4) The binder composition for the secondary battery as set forth in (3) wherein said particulate metal component is constituted by at least one metal selected from the group consisting of Fe, Ni, and Cr.

(5) A slurry for the secondary battery electrode comprising the binder composition obtained by the method of production as set forth in (1) or (2), and an electrode active material.

(6) A secondary battery electrode formed by coating the slurry for the secondary battery electrode as set forth in said (5) to a current collector and drying.

(7) A secondary battery including a positive electrode, a negative electrode, and a current collector; wherein at least one of the positive electrode and the negative electrode is the secondary battery electrode as set forth in (6).

### Effects of the Invention

According to the present invention, the binder composition for the secondary battery having little amount of the particulate metal component and having superior stability over time, can be obtained. Thus, by using said binder composition, the slurry having stable constant quality can be produced, and also the stable secondary battery having the constant quality can be produced as well.

Also, if the particulate metal component is present in the battery, there are problems such as the internal short circuit or the self-discharge caused by the dissolution/deposition during the charging or so; however by removing the particulate metal component in the binder composition, the above mentioned problems can be solved and the cycle characteristic of the battery and the safety can be improved.

### BRIEF DESCRIPTION OF THE DRAWINGS

The present invention will be described in detail in the following.

### (The Polymer Dispersion)

The method of production of the binder composition for the secondary battery of the present invention includes the step of removing the particulate metal wherein the particulate metal, included in the polymer dispersion including the polymer and the dispersion medium, is removed.

The polymer dispersion used for the method of production of the present invention comprises the polymer and the dispersion medium. The polymer dispersion according to the present invention refers to the dispersion wherein the binder (the polymer) is dispersed or dissolved in the water or the organic solvent as the dispersion medium.

In case the polymer dispersion is the aqueous type, usually it is the polymer aqueous dispersion wherein the polymer is dispersed in the water, for example, the diene type aqueous polymer dispersion, acrylic type aqueous polymer dispersion, fluoride type aqueous polymer dispersion, silicon type aqueous polymer dispersion or so may be mentioned. Since the binding property with the electrode active material, and the strength and flexibility of the electrode is superior, the diene type aqueous polymer dispersion or acrylic type aqueous polymer dispersion are preferable.

Also, in case the polymer dispersion solution is the non-aqueous type (those using the organic solvent as the dispersion medium), usually, vinyl type polymer such as polyethylene, polypropylene, polyisobutylene, polyvinyl chloride, polyvinyliden chloride, polyvynilyden fluoride, polytetrafluoroethylene, polyvinyl acetate, polyvinyl alcohol, polyvinyl isobutylether, polyacrylonitrile, polymethacrylonitrile, poly methyl methacrylate, poly methyl acrylate, poly ethyl methacrylate, allyl acetate, polystyrene or so; diene type polymer such as polybutadiene, polyisoprene or so; ether type polymer including hetero atoms to the main chain such as polyoxymethylene, polyoxyethylene, poly cyclic thioether, polydimethylsiloxane or so; condensed ester type polymer such as polylactone, poly cyclic anhydride, polyethylene telephthalate, polycarbonate or so; N-methylpyrrolidone (NMP), xylene, acetone, cyclohexame or so dissolved with condensed amide type polymer such as nylon 6, nylon 66, poly-m-phenyleneis ophthalamide, poly-p-phenylenetelephthalamide, polypyromellitimide or so; may be mentioned.

The diene type aqueous polymer dispersion is the aqueous dispersion solution of the polymer including the monomer unit formed by polymerizing the conjugated diene such as butadiene, isoprene or so. The ratios of the monomer unit formed by polymerizing the conjugated diene in the diene type polymer is usually 40 wt % or more, preferably 50 wt % or more, and further preferably 60 wt % or more. As the polymer, the homopolymer of the conjugated diene such as polybutadiene, polyisoprene or so, or the copolymer between the conjugated diene and the copolymerizable monomer, may be mentioned. As for said copolymerizable monomer, α,β-unsaturated nitrile compound such as acrylonitrile, methacrylonitrile or so; unsaturated carboxylic acid such as acrylic acid, methacrylic acid, itaconic acid, fumaric acid or so; styrene type monomer such as styrene, chlorostyrene, vinyl toluene, t-butylstyrene, vinyl benzoate, methyl vinyl benzoate, vinyl naphthalene, chloromethylstyrene, hydroxymethyl styrene, α-methyl styrene, divinyl benzene or so; olefin group such as ethylene, propylene or so; halogen atom containing monomer such as vinyl chloride, vinylidene chloride or so; vinyl ester group such as vinyl acetate, vinyl propionate, vinyl lactate, vinyl benzoate or so; vinylether group such as methyl vinyl ether, ethyl vinyl ether, butyl vinyl ether or so; vinyl ketone group such as methyl vinyl ketone, ethyl vinyl ketone, butyl vinyl ketone, hexyl vinyl ketone, isopropenyl vinyl ketone or so; heterocycle containing vinyl compound such as N-pyrrolidone, vinylpyridine, vinyl imidazol or so may be mentioned.

The acrylic type aqueous polymer dispersion is the aqueous dispersion of polymer including the monomer unit formed by polymerizing acrylic acid ester and/or methacrylic acid ester. The ratios of the monomer unit formed by polymerzing acrylic acid ester and/or methacrylic acid ester are usually 40 wt % or more, preferably 50 wt % or more, and further preferably 60 wt % or more. As for the polymer, the homopolymer of acrylic acid ester and/or methacrylic acid ester, or the copolymer between these and the copolymerizable monomer may be mentioned. As said copolymerizable monomer, unsaturated carboxylic acid such as acrylic acid, methacrylic acid, itaconic acid, fumaric acid or so; carboxylate ester comprising two or more of carbon-carbon double bond such as ethylene glycol dimethacrylate, diethylene glycol dimethacrylate, trimethylol propane triacrylate or so; styrene type monomer such as styrene, chlorostyrene, vinyl toluene, t-butylstyrene, vinyl benzoate, methyl vinyl benzoate, vinyl naphthalene, chloromethylstyrene, α-methyl styrene, divinyl benzene or so; amide type monomer such as acrylamide, N-methylol acrylamide, acrylamide-2-methyl propane sulfate or so; α,β-unsaturated nitrile compound such as acrylonitrile, methacrylonitrile or so; olefin group such as ethylene, propylene or so; diene type monomer such as butadiene, isoprene or so; halogen atom containing monomer such as vinyl chloride, vinylidene chloride or so; vinyl ester group such as vinyl acetate, vinyl propionate, vinyl lactate, vinyl benzoate or so; vinylether group such as methyl vinyl ether, ethyl vinyl ether, butyl vinyl ether or so; vinyl ketone group such as methyl vinyl ketone, ethyl vinyl ketone, butyl vinyl ketone, hexyl vinyl ketone, isopropenyl vinyl ketone or so; heterocycle containing vinyl compound such as N-pyrrolidone, vinylpyridine, vinyl imidazol or so may be mentioned.

When using the binder composition of the present invention as the binder for the positive electrode, the acrylic type polymer particle dispersion solution which is the dispersion of the saturated polymer without the unsaturated bond in the polymer main chain is preferable, since it is superior in the oxidation resistance during the charging.

Also, when using the binder composition of the present invention as the binder for the negative electrode, the diene type polymer particle dispersion is preferable since it is superior in the reduction resistance and has strong binding force.

The polymer dispersion can be obtained by known method. For example, the polymer dispersion (the aqueous dispersion) having the water as the dispersion medium can be obtained by emulsion polymerizing said monomer in the water. The polymer dispersion having the organic solvent as the dispersion medium can be obtained by substituting the solvent to organic solvent from said aqueous dispersion.

In the present invention, the polymer in the polymer dispersion solution is preferably dispersed in a particle form. The number average particle diameter of the polymer particle in the polymer dispersion when dispersed in a particle form is preferably 50 nm to 500 nm, and further preferably 70 nm to 400 nm. When the number particle diameter of the polymer particle is within this range, it is preferable since the obtained electrode has good strength and flexibility.

The glass transition temperature (Tg) of the polymer in the polymer dispersion is selected according to the use, however it is usually −150° C. to +100° C., preferably −50° C. to +5° C., and more preferably −35° C. to +25° C. When the Tg of the polymer is within this range, the characteristics such as the flexibility of the electrode, the binding property and the winding property, the adhesive property between the active material layer and the current collectors, are balanced out hence it is suitable.

The solid portion concentration of the polymer dispersion is usually 15 to 70 wt %, preferably 20 to 65 wt %, and more preferably 30 to 60 wt %. When the solid portion concentration is within this range, the processing during the production of the slurry for the electrodes is superior.

The viscosity of the polymer dispersion is usually 5 to 10000 mPa·s, preferably 8 to 5000 mPa·s, and more preferably 10 to 1000 mPa·s. When the viscosity of the polymer dispersion solution is within this range, the filterability of the magnetic filter, which will be described hereinafter, is superior, and the processing during the production of the slurry for the electrodes is superior. The viscosity of the polymer dispersion is measured according to the JIS Z8803:1991 using single cylinder shape rotational visometer (25° C., rotation speed=60 rpm, spindle shape: 4).

### (The Method of Removing the Particulate Metal Component in the Polymer Dispersion)

The present invention includes the step of removing the particulate metal wherein the particulate metal in the polymer dispersion, including the polymer and the dispersion medium, is removed.

In the present invention, the particulate metal refers to those present in the polymer dispersion in a particle form, and does not include those present in a metal ion state by dissolving.

The method of removing the particulate metal component from the polymer dispersion during the step of removing the particulate metal is not particularly limited, and for example, the method of removing by filteration using the filter, the method of removing by the vibrating sieve, the method of removing by the centrifugal separation, the method of removing by magnetic force or so may be mentioned. Among these, since the objects of being removed are a metal component, the method of removing by magnetic force is preferable.

As the method of removing by the magnetic force, it is not particularly limited as long as it is the method capable to remove the metal component, however by considering the productivity and the removal efficiency, the method of placing the magnetic filter in the production line of the binder composition for the secondary battery and removing by passing through the polymer dispersion is preferable.

The step of removing the particulate metal component from the polymer dispersion by the magnetic filter is preferably carried out by passing through the magnetic filter forming the magnetic field of 100 gauss or more of magnetic flux density. When the magnetic flux density is low, the removal efficiency of the metal component is lowered, thus it is preferably 1000 gauss or more, when considering the removal of the stainless which have weak magnetic property it is more preferably 2000 gauss or more and most preferably 5000 gauss or more.

When placing the magnetic filter in the production line, it is preferable to comprise the step of removing the bulky foreign materials or the metal particle by the filter such as the cartilage filter or so at the upper stream of the magnetic filter. This is due to the fact that the above mentioned bulky metal particle may pass the magnetic filter depending on the flow speed of the filteration.

Also, the magnetic filter is effective by filtering once, however preferably it is the circulation type. By using the circulation type, the removal efficiency of the metal particle can be improved.

When placing the magnetic filter in the production line of the binder composition for the secondary battery, the position of placement of the magnetic filter is not particularly limited; however, in case the filtration step by the conventional filter is present before the binder composition for the secondary battery is filled into the container, the magnetic filter is preferably placed in front of the conventional filter. This is to prevent the metal component from being mixed in to the product in case the metal component was not cached by the magnetic filter.

### (The Binder Composition for the Secondary Battery)

The binder composition for the secondary battery of the present invention is obtained by removing the particulate metal included in said dispersion with respect to the polymer dispersion including at least the polymer and the dispersion medium by using the production method of the present invention mentioned in above.

The metal constituting said particulate metal component is not particularly limited; however, it is preferably at least one selected from the group consisting of Fe, Ni, and Cr. According to the present invention, the particulate metal refers to those present in a particle form in the binder composition, and does not refer to those present in a metal ion form by dissolving.

Above mentioned particulate metal component may remain in the binder composition for the secondary battery; however the content of the particulate metal component having the particle diameter of 20 μm or more included in the binder composition for the secondary battery of the present invention is 10 ppm or less. In the present invention, by having the content of 10 ppm or less of the particulate metal component having the particle diameter of 20 μm or more included in the binder composition for the secondary battery, the metal ion crosslinking between the polymer in the binder composition for the secondary battery over time can be prevented, the increase of the viscosity can be prevented, and further the possibility of the internal short circuit or the self-discharge due to the dissolution/deposition due to the charging of the secondary battery can be lowered, hence the cycle characteristic or the safety of the battery can be improved.

By filtering the binder composition for the secondary battery, of which the particulate metal included in the dispersion has been removed, using the mesh opening equivalent to 20 μm, then the element of the metal particle left on the mesh is analyzed using the electron probe X ray microanalyzer (EPMA), and the metal is dissolved by the acid which can dissolve said metal and the dissolved object is measured by the ICP (Inductively Coupled Plasma); thereby the content of the particulate metal component having the particle diameter of 20 μm or more included in the binder composition for the secondary battery can be measured.

The binder composition for the secondary battery of the present invention has good storage stability, hence it may be used as the binder composition for the porous film used as the protection film of the binder composition for the secondary battery or the secondary battery electrode.

### (The Slurry for the Secondary Battery Electrode)

The slurry for the secondary battery electrode comprises said binder composition for the secondary battery and the electrode active material.

### (The Electrode Active Material)

As the electrode active material used in the present invention, it can be suitably selected depending on the secondary battery wherein the electrode is used. As said secondary battery, the lithium ion secondary battery or the nickel metal hydride secondary battery may be mentioned.

As the electrode active material used in the lithium ion secondary battery, it only needs to be those which can introduce and release the lithium ion reversibly by applying the electric potential in the electrolytes, and it may be inorganic compounds or organic compounds.

As the electrode active material of the positive electrode, for example, lithium containing composite metal oxides such as LiCoO₂, LiNiO₂, LiMnO₂, LiMn₂O₄, LiFeVO₄, LiₓNi_{y}Co_{z}Mn_{w}O₂ (note that x+y+z+w=2) or so; lithium containing composite metal oxo oxide salts such as LiFePO₄, LiMnPO₄, LiCoPO₄ or so; transition metal sulfides such as TiS₂, TiS₃, amorphous MoS₃ or so; transition metal oxides such as Cu₂V₂O₃, amorphous V₂O—P₂O₅, MoO₃, V₂O₅, V₆O₁₃ or so; and the compound wherein a part of the transition metals of said compounds are substituted to other metals or so may be mentioned. Further, the conductive macromolecule such as polyacetylene, poly-p-phenylene or so may be used as well. Also, those coverting a part or the entire surface thereof with the carbon material or the inorganic compound may be used as well.

Also, as the electrode active material of the negative electrode, for example, carbon materials such as amorphous carbon, graphite, natural graphite, artificial graphite, mesocarbon microbeads (MCMB), pitch type carbon materials or so; the conductive macromolecule such as polyacene or so may be mentioned. Also, the metals such as Si, Sn, Sb, Al, Zn, and W or so which can be alloy with the lithium and the alloy thereof may be mentioned as well. The electrode active material which is adhered with the conductive material on the surface using the mechanical modifying method may be used. Also, the above mentioned electrode active material may be used by mixing.

Among these, it is preferable to use the lithium containing composite metal oxide and the lithium containing composite oxo oxides as the positive electrode, and the carbon fibers as the negative electrodes, since it is, easier to obtain high capacity, stable at high temperature, has small volume change along with the introduction and release of the lithium ion, and easier to reduce the changing rate of the electrode thickness.

As the electrode active material for the positive electrode (the positive electrode active material) of the nickel metal hydride secondary battery, nickel hydroxide particle may be mentioned. The nickel hydroxide particle may solid dissolve cobalt, zinc, cadmium or so, or the surface may be covered by the cobalt compound which is alkali thermal treated. Also, the nickel hydroxide particle may include the additives such as yttrium oxides, the cobalt compounds such as cobalt oxides, cobalt metals, cobalt hydroxides or so, the zinc compound such as zinc metal, zinc oxides, zinc hydroxides or so, the rare earth compounds such as erbium oxides or so.

When using the secondary battery of the present invention as the negative electrode of the nickel metal hydride secondary battery, the hydrogen absorbing alloy particle may be mentioned as the electrode active material of the negative electrode (the negative electrode active material) of the nickel metal hydride secondary battery. The hydrogen absorbing alloy particle only needs to be those which can absorb the hydrogen generated electrochemically in the alkali electrolyte solution during the charging of the battery, also can easily release said absorbed hydrogen during the discharging; hence it is not particularly limited; however the particle is preferably formed by the hydrogen absorbing alloy of AB5 type, TiNi type, and TiFe type. Specifically, for example, the hydrogen absorbing alloy particle of the multi element type wherein a part of Ni of LaNi₅, MmNi₅ (Mm is mesh metal), LmNi₅ (Lm is at least one selected from the rare earth element including La) and the alloy thereof are substituted by the element selected from at least one of the group consisting Al, Mn, Co, Ti, Cu, Zn, Zr, Cr, and B or so may be used. Particularly the hydrogen absorbing alloy particle having the composition expressed by the general formula: LmNi_{w}CoₓMn_{y}Al_{z} (the total value of the atomic ratio w, x, y and z is 4.80≦w+x+y+z≦5.40) is preferable since the pulverization along with the charge-discharge cycle progress is suppressed hence the lifetime of the charge-discharge cycle is improved.

The particle form of the electrode active material is not particularly limited. For example, a squamous form, a bulk form, a fiber form, a sphere form or so can be used. The negative electrode active material is preferably a powder having the average particle diameter of 0.1 to 100 μm in order to disperse uniformly during the pasting of the layer. These electrode active materials may be used alone or by mixing two or more thereof.

The total used amount of the binder and the electrode active material in the slurry for the secondary battery electrode is preferably 10 to 90 parts by weight and further preferably 30 to 80 parts by weight with respect to 100 parts by weight of the slurry. The used amount of the active material in the slurry for the electrode is preferably 5 to 80 parts by weight and further preferably 10 to 60 parts by weight with respect to 100 parts by weight of the slurry. When the total amount of each component and the used amount of the active material is within this range, the viscosity of the obtained slurry is adjusted hence the pasting can be carried out smoothly.

The used amount of the binder in the slurry for the secondary battery electrode is, in solid portion equivalent, preferably 0.1 to 10 parts by weight, more preferably 0.5 to 8 parts by weight, and particularly preferably 0.7 to 1.2 parts by weight with respect to 100 parts by weight of the electrode active material. When the used amount is within this range, the strength and the flexibility of the obtained electrode becomes superior.

### (The Viscosity Thickener)

The slurry for the secondary battery electrode of the present invention may comprise the viscosity thickener. As the viscosity thickener, the cellulose type polymer such as carboxymethyl cellulose, methyl cellulose, hydroxylpropyl cellulose or so and the ammonium salts and alkali metal slats thereof; (modified) poly(meth)acrylic acid and the ammonium salts and the alkali metal salts thereof; the polyvinyl alcohol groups such as (modified) poly vinyl alcohol, the copolymer of acrylic acid or the acrylic acid salts and the vinyl alcohol, the copolymer of the maleic acid unhydride or the fumaric acid and the vinyl alcohol; polyethylene glycol, polyethylene oxide, poly vinyl pyrrolidone, modified poly acrylic acid, oxidized starch, phosphoric acid starch, casein, various modified starch or so may be mentioned. The used amount of the viscosity thickener is preferably 0.5 to 1.5 parts by weight with respect to 100 parts by weight of electrode active material. When the used amount of the viscosity thickener is within this range, the pasting property, the binding property with the current collector are superior. In the present invention, “(modified) poly” refers to “unmodified poly” or “modified poly”, and “(meth)acrylic” refers to “acrylic” or “methacrylic”.

### (The Conductive Material)

The slurry for the secondary battery electrode of the present invention may comprise the conductive material. As the conductive material, the conductive carbons such as acetylene black, ketjen black, carbon black, graphite, gas phase grown carbon fiber, and carbon nanotube or so may be used. By using the conductive material, the electrical contact between the electrode active materials can be improved and the discharge rate characteristic in case of using the non-aqueous electrolyte secondary battery can be improved. The used amount of the conductive material is usually 0 to 20 parts by weight and preferably 1 to 10 parts by weight with respect to 100 parts by weight of the electrode active material.

### (The Method of Production of the Slurry for the Secondary Bbattery Electrode)

The slurry for the secondary battery electrode is obtained by mixing the above mentioned binder composition for the secondary battery, the electrode active material, the viscosity thickener which is added if needed, and the conductive material or so.

The method of mixing is not particularly limited, and for example, the method using the mixing apparatus such as the stirring type, the vibrating type, and the rotating type may be mentioned. Also, the method of using the dispersion kneading apparatus such as the homogenizer, the ball mill, the sand mill, the roll mill, and planetary mixer or so may be mentioned as well.

### (The Secondary Battery Electrode)

The binder composition for the secondary battery of the present invention, the slurry for the secondary battery electrode comprising the positive electrode active material and the negative electrode active material is pasted to the current collector and dried; thereby the secondary battery electrode of the present invention is obtained.

The method of production of the secondary battery electrode of the present invention is not particularly limited; however for example, the method of pasting said slurry for the secondary battery electrode to at least one surface of the current collector or preferably to the both surface of the current collector, then heat drying to form the electrode active material layer may be mentioned.

The method of pasting the slurry for the secondary battery electrode to the current collector is not particularly limited. For example, the methods such as the doctor blade method, the dip method, the reverse roll method, the direct roll method, the gravure method, the extrusion method and the brushing method or so may be mentioned.

For example as the drying method, the drying by warm air, hot air and low humidified air, the vacuum drying, the drying method by the irradiation of the (far) infrared beam or the electron beam or so may be mentioned. The drying time is usually 5 to 30 minutes, and the drying temperature is usually 40 to 180° C.

When producing the secondary battery electrode, after the slurry for the secondary battery electrode is pasted and heat dried, it is preferable that the porosity of the active material layer is reduced by the pressure applying treatment using the press mold or the roll press or so. The preferable porosity range is 5% to 15%, and more preferably 7% to 13%. When the porosity is too high, the charging efficiency and the discharging efficiency are deteriorated. In case the porosity is too low, it is difficult to obtain the high volume capacity, and the active material layer is easily released from the current collector which easily caused the malfunctions.

Further, when using the curable polymer, it is preferably cured.

The thickness of the electrode active material layer of the secondary battery electrode of the present invention is usually 5 μm or more and 300 μm or less, and preferably 30 μm or more and 250 μm or less.

### (The Current Collector)

The current collector used in the present invention is not particularly limited as long as it is a material having the conductivity and the electrochemical resistance, and preferably it is a metal material since it comprises the heat resistance. For example, copper, aluminum, nickel, titanium, tantalum, gold, platinum or so may be mentioned. Among these, aluminum is particularly preferable as the positive electrode, and copper is particularly preferable as the negative electrode. The shape of the current collector is not particularly limited; however it preferably has a sheet form having the thickness of 0.001 to 0.5 mm or so. The current collector is preferably used by carrying out the roughening treatment in advance in order to increase the binding strength with the electrode active material layer. As the roughening method, the mechanical abrasive method, the electrolyte abrasive method, the chemical abrasive method or so may be mentioned. As the mechanical abrasive method, the coated abrasive adhered with the abrasive particle, the grind stone, the emery wheel and the wire brush equipped with steel wire or so may be used. Also, the intermediate layer may be formed on the surface of the current collector in order to increase the binding strength and the conductivity of the electrode active material layer.

### (The Secondary Battery)

The secondary battery of the present invention is the secondary battery including the positive electrode, the negative electrode, and the electrolyte solution, wherein at least one of the positive electrode and the negative electrode is said secondary battery electrode.

As said secondary battery, the lithium ion battery, the nickel metal hydride battery or so may be mentioned; however, particularly in the present invention, the lithium ion secondary battery having a heavy weight on the safety is preferable. Hereinafter, the secondary battery electrode of the present invention will be described in case of using to the lithium ion secondary battery.

### (The Electrolyte Solution)

The electrolyte solution used in the lithium ion secondary battery is not particularly limited as long as it is used for the lithium ion secondary battery; and for example, the electrolyte solution dissolved the lithium salts as the supporting electrolyte to the non-aqueous solvent may be used. As the lithium salts, for example, LiPF₆, LiAsF₆, LiBF₄, LiSbF₆, LiAlCl₄, LiClO₄, CF₃SO₃Li, C₄F₉SO₃Li, CF₃COOLi, (CF₃CO)₂NLi, (CF₃SO₂)₂NLi, (C₂F₅SO₂)NLi or so may be mentioned. LiPF₆, LiClO₄, CF₃COOLi which easily dissolves and show high degree of dissociation are used preferably. These may be used alone or by mixing two or more thereof. The amount of the supporting electrolytes is usually 1 wt % or more, preferably 5 wt % or more, and usually 30 wt % or less and preferably 20 wt % or less with respect to the electrolyte solution. When the amount of the supporting electrolytes is too little or too much, the ionic conductivity is lowered and the charging characteristic and the discharging characteristic are lowered.

The solvent used for said electrolyte solution is not particularly limited as long as the supporting electrolytes can be dissolved; however alkyl carbonate groups such as dimethyl carbonate (DMC), ethylene carbonate (EC), diethyl carbonate (DEC), propylene carbonate (PC), butylenes carbonate (BC), and methylethyl carbonate (MEC) or so; ester groups such as y-butyrolactone, methyl formate or so; ether groups such as 1,2-dimethoxyethane, tetrahydrofuran or so; sulfur containing compounds such sulfolane, dimethylsulfoxide or so may be used. Dimethyl carbonate, ethylene carbonate, propylene carbonate, diethyl carbonate, methylethyl carbonate are preferable since particularly high ionic conductivity can be obtained and the temperature range of the use is wide. These may be used alone, or by mixing two or more thereof.

Also, said electrolyte solution may be used by adding the additives. As the additives, carbonate type compound such as vinylene carbonate (VC) or so is preferable.

As the electrolyte solution besides the above mentioned, the gel form polymer electrolytes wherein the polymer electrolytes such as polyethylene oxide, polyacrylonitrile or so is impregnated in the electrolyte solution, or the inorganic solid electrolytes such as LiI, Li₃N or so may be mentioned.

Also, when using the present invention to the nickel metal hydride secondary battery, the electrolyte solution which is conventionally used for the nickel metal hydride secondary battery may be used without any particular limitation.

### (The Separator)

As the separator, known separators such as the fine porous film or the nonwoven fabric comprising aromatic polyamide resin or the polyolefin resin such as polyethylene, polypropylene or so; the porous resin coat including the inorganic ceramic powder, may be used. For example, the fine porous film formed by the resin such as polyolefin type polymer (polyethylene, polypropylene, polybutene, polyvinyl chloride) and the mixture or the copolymer thereof or so; the fine porous film formed by the resin such as polyethylene telephthalate, polycycloolefin, polyether sulfone, polyamide, polyimide, polyimideamide, polyaramid, polycycloolefin, nylon, polytetrafuluoro ethylene or so, the woven fabric wherein the polyolefin type fiber are woven or the non-woven fabric thereof, and the aggregate of the insulating material particles or so may be mentioned. Among these, the fine porous film formed by the polyolefin type resin is preferable since the thickness of the separator as a whole can be made thinner and the capacity per volume can be increased by increasing the active material ratio in the battery.

The thickness of the separator is usually 0.5 to 40 μm, preferably 1 to 30 μm, and more preferably 1 to 10 μm. When it is within this range, the resistance of the separator in the battery becomes smaller, and the processing while forming the battery is superior.

### (The Production Method of the Battery)

The method of producing the secondary battery of the present invention is not particularly limited. For example, the negative electrode and the positive electrode is stacked via the separator, and this is rolled up or bent according to the shape of the battery to place in the battery container, then the battery container is closed after the electrolyte is introduced therein. If needed, the expand metal, the fuse, the over current prevention element such as PTC element, the lead plate or so may be placed in order to prevent the pressure rising in the battery and the excessive charge-discharge. The shape of the battery may be any one of the coin type, the button type, the sheet type, the cylinder type, the square type, or the flatten type or so.

### EXAMPLES

Hereinafter the present invention will be described based on the examples, however the present invention is not to be limited thereto. Note that, “parts” and “%” in the present examples are based on the weight unless mentioned otherwise.

Various measurements in each example were carried out as the following.

### (1) The Element Analysis of the Particulate Metal Component

The particulate metal left on the mesh by the below (2) was identified by the electron probe X ray microanalyzer (EPMA).

### (2) The Content of the Particulate Metal Component

The binder composition prepared in the examples and the comparative examples were filtered using the mesh having the opening of 20 μm, then the particulate metal left on the mesh was dissolved by the acid thereby the content of the particulate metal in the binder composition was measured using the ICP (Inductively Coupled Plasma).

### (3) The Storage Stability

The viscosity of the binder composition before storing for 90 days at room temperature, and the viscosity of the binder composition after storing for 90 days at room temperature were measured, and the viscosity ratio was calculated by the following equation. Thereby the storage stability was determined based on the 4 standards listed in the following.

The viscosity ratio=(the viscosity of the binder composition after storing for 90 days)/(the viscosity of the binder composition before storing for 90 days)
A: less than 1.1
B: 1.1 or more and less than 1.2
C: 1.2 or more and less than 1.3
D: 1.3 or more

Note that the viscosity of the binder composition for the secondary battery was measured according to JIS Z8803:1991 using the single cylinder rotational viscometer (25° C., rotation speed=60 rpm, spindle shape: 1).

### (4) The Battery Characteristic: The Cycle Characteristic

To the lithium ion secondary battery having the coin shape, by using the constant current charge method of 0.1 C at 25° C., fifty repeats of the charge-discharge were carried out wherein for the evaluation of the negative electrode it was charged from 0.2V to 2.5V and for the evaluation of the positive electrode it was charged from 3.0V to 4.2V. The value calculated in percentile of the ratio of discharge capacity at 50th cycle with respect to the discharge capacity at the 5th cycle was determined as the capacity maintaining rate, and was evaluated based on the following standards. The larger this value is, the lesser the discharge capacity reduction is, and thus it shows a good result.
A: 60% or more
B: 50% or more and less than 60%
C: 40% or more and less than 50%
D: less than 40%

### (5) The Battery Characteristic: The Short Circuit Malfunction Ratio

The lithium ion secondary battery (n=10) having the coin shape was charged from 0.2V to 1.5V by the constant current charge method of 0.1 C at 25° C. After the charging, the open-circuit voltage of the battery was verified, then the number of the cells in the short circuit status was determined as the short circuit ratio, and it was evaluated based on the following standards. The fewer the numbers of cells at the short circuit status are, the better the results are.
A: 0 cell
B: 1 cell or more and 2 cells or less.
C: 3 cells or more and 6 cells or less
D: 7 cells or more

### Example 1

As the polymer A, by using the emulsifying polymerization method, the diene type aqueous polymer particle dispersion (the solid portion amount 50%, the number particle diameter 150 nm, the glass transition temperature −80° C.) comprising the structure unit derived from the monomer shown in Table 1 was obtained.

As the polymer B, by using the emulsifying polymerization method, polybutadiene (diene type polymer) aqueous dispersion solution (the solid portion content 50%, the number particle diameter 150 nm, and the glass transition temperature −7° C.) comprising 1,2-vinyl structure content of 18% was obtained.

The obtained polymer A and B were mixed so that the weight ratio of the polymer component is 95:5, thereby the binder aqueous dispersion (the solid portion concentration 50%, the viscosity 14.0 mPa·s) was obtained.

The obtained binder aqueous dispersion solution was passed through the pre-filter, and filtered via the magnetic filter (made by TOK Engineering Co., Ltd.) under the condition at room temperature and the magnetic flux density of 8000 gauss, then the binder composition 1 for the secondary battery (the solid portion concentration 50%) was obtained. When the magnetic filter after the filtration was observed, the particulate metals were adhered to the magnetic filter.

When the particle diameter of the particulate metals adhered on the magnetic filter was observed by the light microscope, the plurality of particulate metals having the diameter of 50 to 300 μm was obtained.

The obtained binder composition 1 for the secondary battery was filtered using the mesh according to the above mentioned method, and the composition analysis was carried out by measuring the constituting metal component of the remained particulate metal by electron probe X ray microanalyzer (EPMA), thereby it was verified that Fe, Ni, and Cr were included as the main component.

The results of the content of the particulate metal in the obtained binder composition 1 being measured are shown in Table 2. Also, the evaluation results of the storage stability are shown in Table 2 as well.

### (The Production of the Slurry for the Electrode)

As carboxymethyl cellulose, carboxymethyl cellulose having the solution viscosity of 8000 mPa·s (made by DAI-ICHI KOGYO SEIYAKU CO., LTD, CELLOGENBSH-12) was used, and prepared 1% aqueous solution.

100 parts of the artificial graphite having the average particle diameter of 24.5 μm as the electrode active material was introduced into the planetary mixer having the disperser, and 100 parts of above mentioned aqueous solution was added thereto, then controlled to have solid portion concentration of 53.5% using the ion exchange water followed by mixing for 60 minutes at 25° C. Next, it was controlled to have the solid portion concentration of 44% using the ion exchange water, then further mixed for 15 minutes at 25° C. Then, 2.9 parts of the binder composition 1 which has been stored for 90 days at room temperature as mentioned above were introduced, and further mixed for 10 minutes. The slurry for the electrode having good fluidity and luster was obtained by carrying out the defoaming treatment thereto.

### (The Production of the Battery)

The above mentioned slurry for the electrode was coated using the comma coater on the one side of the copper foil having the thickness of 18 μm so that the film thickness after drying becomes 100 μm or so, and dried for 20 minutes at 60° C., then heat treated for 2 hours at 150° C. thereby obtained the electrode. This electrode was stretched by applying the pressure using the roll press and obtained the negative electrode having the thickness of 170 μm. When the coated thickness of the obtained electrode was measured, the film thickness was approximately even.

Said negative electrode was cut out in a disk form having the diameter of 15 mm, and on to the active material layer side of this negative electrode, the separator formed by the polypropylene porous film of the disk form having the diameter of 18 mm and the thickness of 25 μm, the metallic lithium used as the positive electrode and the expand metal were stacked in this order. Then, this was placed in the coin shape outer container made of stainless steel (the diameter 20 mm, the height 1.8 mm, the thickness of the stainless steel 0.25 mm) provided with the polypropylene packing. The electrolyte solution was introduced in to this container so that no air remains, and fixed by covering the cap made of the stainless steel having the thickness of 0.2 mm to the outer container via the polypropylene packing, and the battery can was closed thereby the lithium ion secondary battery of the coin shape having the diameter of 20 mm and the thickness of about 2 mm was produced.

By using the obtained coin shape secondary battery, the cycle characteristics and the short circuit malfunction ratio were measured, and the results are shown in Table 2.

### Example 2

The magnetic flux density of the magnetic filter in the example 1 was changed to 2000 gauss. Other than that, the filtration was carried out as same as the example 1 and the binder composition 2 for the secondary battery (The solid portion concentration 50%) was produced.

When the magnetic filter after the filtration was observed the particulate metals were adhered to the magnetic filter.

When the particle diameter of the particulate metals adhered on the magnetic filter were observed by the light microscope, the plurality of particulate metals having the diameter of 50 to 300 μm was obtained.

The obtained binder composition 2 for the secondary battery was filtered by the mesh according to the above mentioned method, and the composition analysis was carried out by measuring the constituting metal component of the particulate metal remained using the electron probe X ray microanalyzer (EPMA), then it was verified that Fe, Ni and Cr were included as the main component.

The result of the content of the particulate metal in the obtained binder composition 2 is shown in Table 2. Also, the evaluation result of the storage stability is shown in Table 2 as well.

In stead of the binder composition 1 for the secondary battery in the example 1, the binder composition 2 for the secondary battery was used in the example 2. Other than that, the electrode slurry, the electrode, and the coin shape lithium secondary battery were produced as same as the example 1 and evaluated. The results are shown in Table 2.

### Example 3

300 parts of ion exchange water, 41 parts of n-butyl acrylic acid, 41.5 parts of ethyl acrylic acid, 15 parts of acrylonitrile, 2.0 parts of glycidyl methacrylate, 0.5 parts of 2-acrylamide 2-methylpropane sulfonic acid, 0.05 parts of t-dodecylmelcaptane as the molecular weight modifier, 0.3 parts of potassium persulfate as the polymerization initiator were introduced into the autoclave having the stirrer, and stirred sufficiently, then polymerized by heating at 70° C., thereby the acrylic type aqueous polymer dispersion (the polymer C, the glass transition temperature 0° C.) was obtained. The polymerization conversion rate obtained from the solid portion concentration was approximately 99.9%. 320 parts of N-methyl pyrrolidone (hereinafter it may be referred to as “NMP”) were added to 100 parts of this polymer C and the water was evaporated under the reduced pressure, and the binder solution was obtained. The solid portion concentration of the obtained binder solution was 8%, and the viscosity was 620 mPa·s.

To the obtained binder solution, the filtration was carried out by the pre-filter and the magnetic filter (made by TOK Engineering Co., Ltd.) under the condition of room temperature, the magnetic flux of 8000 gauss; thereby the binder composition 3 for the secondary battery (the solid portion concentration 8%) was obtained. When the magnetic filter after the filtration was observed, the particulate metals were adhered to the magnetic filter.

When the particle diameter of the particulate metals adhered on the magnetic filter was observed by the light microscope, the plurality of particulate metals having the diameter of 50 to 300 μm were obtained.

The obtained binder composition 3 for the secondary battery was filtered using the mesh according to the above mentioned method, and the composition analysis was carried out by measuring the constituting metal component of the remained particulate metal by electron probe X ray microanalyzer (EPMA), thereby it was verified that Fe, Ni, and Cr were included as the main component.

The result of the content of the particulate metal in the obtained binder composition 3 is shown in Table 2. Also, the evaluation result of the storage stability is shown in Table 2 as well.

### (The Production of the Slurry for the Electrode)

100 parts of lithium cobalate having the average particle diameter of 24.5 μm as the electrode active material was introduced into the planetary mixer having the disperser, and 25 parts of said binder composition 3 which has been stored for 90 days at room temperature was added thereto, then mixed for 60 minutes at 25° C. Next the solid portion concentration was controlled to 75% using NMP, and further mixed for 15 minutes at 25° C. The slurry for the electrode having good fluidity and luster was obtained by carrying out the defoaming treatment thereto.

(The Production of the Battery)

The above mentioned slurry for the electrode was coated using the comma coater on the one side of the aluminum foil having the thickness of 20 μm so that the film thickness after drying becomes 200 μm or so, and dried for 20 minutes at 60° C., then heat treated for 2 hours at 150° C. thereby obtained the electrode. This electrode was stretched by applying the pressure using the roll press and obtained the positive electrode having the thickness of 170 μm. When the coated thickness of the obtained electrode was measured, the film thickness was approximately even.

Said negative electrode was cut out in a disk form having the diameter of 15 mm, and on to the active material layer side of this positive electrode, the separator formed by the polypropylene porous film of the disk form having the diameter of 18 mm and the thickness of 25 μm, the metallic lithium used as the negative electrode and the expand metal were stacked in this order. Then, this was placed in the coin shape outer container made of stainless steel (the diameter 20 mm, the height 1.8 mm, the thickness of the stainless steel 0.25 mm) provided with the polypropylene packing. The electrolyte solution was introduced in to this container so that no air remains, and fixed by covering the cap made of the stainless steel having the thickness of 0.2 mm to the outer container via the polypropylene packing, and the battery can was closed thereby the lithium ion secondary battery of the coin shape having the diameter of 20 mm and the thickness of about 2 mm was produced.

By using the battery produced as same as the example 1, the cycle characteristic and the short circuit malfunction ratio was measured and the results are shown in Table 2.

### Example 4

The magnetic flux density of the magnetic filter in the example 3 was changed to 2000 gauss. Other than that, the filtration was carried out as same as the example 3 and the binder composition 4 for the secondary battery was obtained.

When the magnetic filter after the filtration was observed, the particulate metals were adhered to the magnetic filter.

When the particle diameter of the particulate metals adhered on the magnetic filter were observed by the light microscope, the plurality of particulate metals having the diameter of 50 to 300 μm was obtained.

The obtained binder composition 4 for the secondary battery was filtered using the mesh according to the above mentioned method, and the composition analysis was carried out by measuring the constituting metal component of the remained particulate metal by electron probe X ray microanalyzer (EPMA), thereby it was verified that Fe, Ni, and Cr were included as the main component.

The result of the content of the particulate metal in the obtained binder composition 4 is shown in Table 2. Also, the evaluation result of the storage stability is shown in Table 2 as well.

In stead of the binder composition 3 for the secondary battery in the example 3, the binder composition 4 for the secondary battery was used in the example 4. Other than that, the electrode slurry, the electrode, and the coin shape lithium secondary ion were produced as same as the example 3 and evaluated. The results are shown in Table 2.

### Example 5

The polymer C was produced as same as the example 3, and 460 parts of NMP was added to 100 parts of the polymer C then the water was evaporated under the reduced pressure, thereby obtained the binder solution. The solid portion concentration of the obtained binder solution was 6%, and the viscosity of 250 mPa·s.

Said binder solution was used in the example 5, and other than that the filtration was carried out as same as the example 3 thereby the binder composition 5 for the secondary battery was obtained.

When the magnetic filter after the filtration was observed, the particulate metal was adhered to the magnetic filter.

The obtained binder composition 5 for the secondary battery was filtered using the mesh according to the above mentioned method, and the composition analysis was carried out by measuring the constituting metal component of the remained particulate metal by electron probe X ray microanalyzer (EPMA), thereby it was verified that Fe, Ni, and Cr were included as the main component.

The result of the content of the particulate metal in the obtained binder composition 5 is shown in Table 2. Also, the evaluation result of the storage stability is shown in Table 2 as well.

In stead of the binder composition 3 for the secondary battery in the example 3, the binder composition 5 for the secondary battery was used in the example 5. Other than that, the electrode slurry, the electrode, and the coin shape lithium secondary ion were produced as same as the example 3 and evaluated. The results are shown in Table 2.

### Example 6

In stead of using the binder solution of the example 3, the binder solution obtained in example 5 was used, and the magnetic flux density of the magnetic filter was set to 2000 gauss, other than that, the filtration was carried out as same as the example 3 and the binder composition 6 for the secondary battery was obtained.

When the magnetic filter after the filtration was observed, the particulate metals were adhered to the magnetic filter.

When the particle diameter of the particulate metals adhered on the magnetic filter was observed by the light microscope, the plurality of particulate metals having the diameter of 50 to 300 μm was obtained.

The obtained binder composition 6 for the secondary battery was filtered using the mesh according to the above mentioned method, and the composition analysis was carried out by measuring the constituting metal component of the remained particulate metal by electron probe X ray microanalyzer (EPMA), thereby it was verified that Fe, Ni, and Cr were included as the main component.

The result of the content of the particulate metal in the obtained binder composition 6 is shown in Table 2. Also, the evaluation result of the storage stability is shown in Table 2 as well.

In stead of the binder composition 3 for the secondary battery in the example 3, the binder composition 6 for the secondary battery was used in the example 6. Other than that, the electrode slurry, the electrode, and the coin shape lithium secondary ion were produced as same as the example 3 and evaluated. The results are shown in Table 2.

### The Comparative Example 1

The binder dispersion was not passed through the magnetic filter unlike in the example 1. Other than that, the binder composition 7 was prepared as same as the example 1, and carried out the element analysis of the particulate metal component, and evaluated the content of the particulate metal component, and the storage stability. The results are shown in Table 2.

Also, in stead of the binder composition 1 of the secondary battery in the example 1, the binder composition 7 for the secondary battery was used. Other than that, the electrode slurry, the electrode, and the coin shape lithium secondary battery was produced as same as the example 1 and was evaluated. The results are shown in Table 2.

### The Comparative Example 2

The binder dispersion solution was not passed through the pre-filter and the magnetic filter unlike in the example 1. Other than that, the binder composition 8 was prepared as same as the example 1 and carried out the element analysis of the particulate metal component, and evaluated the content of the particulate metal component, and the storage stability. The results are shown in Table 2.

Also, in stead of the binder composition 1 of the secondary battery in the example 1, the binder composition 8 for the secondary battery was used. Other than that, the electrode slurry, the electrode, and the coin shape lithium secondary battery was produced as same as the example 1 and was evaluated. The results are shown in Table 2.

### The Comparative Example 3

The binder dispersion solution was not passed through the magnetic filter unlike in the example 3. Other than that, the binder composition 9 (the solid portion concentration 8 wt %, the viscosity 620 mPa·s) was prepared as same as the example 3, and carried out the element analysis of the particulate metal component, and evaluated the content of the particulate metal component, and the storage stability. The results are shown in Table 2.

Also, in stead of the binder composition 3 of the secondary battery in the example 3, the binder composition 9 for the secondary battery was used. Other than that, the electrode slurry, the electrode, and the coin shape lithium secondary battery was produced as same as the example 3 and was evaluated. The results are shown in Table 2.

### The Comparative Example 4

The binder dispersion solution was not passed through the pre-filter and the magnetic filter unlike in the example 3. Other than that, the binder composition 10 (the solid portion concentration 8 wt %, the viscosity 620 mPa·s) was prepared as same as the example 3 and carried out the element analysis of the particulate metal component, and evaluated the content of the particulate metal component, and the storage stability. The results are shown in Table 2.

Also, in stead of the binder composition 3 of the secondary battery in the example 3, the binder composition 10 for the secondary battery was used. Other than that, the electrode slurry, the electrode, and the coin shape lithium secondary battery was produced as same as the example 3 and was evaluated. The results are shown in Table 2.

TABLE 1

| Composition of Polymer A | wt % |
|---|---|
| metylmethacrylate | 16.4 |
| hydroxyethylacrylate | 1.0 |
| itaconic acid | 2.5 |
| 1,3 butadiene | 41.1 |
| styrene | 32.7 |
| acrylonitrile | 5.1 |
| acrylamide | 1.2 |

TABLE 2

| | | | | | | Content | | | |
|---|---|---|---|---|---|---|---|---|---|
| | | | | Magnetic | | of the | | | |
| | | Solid portion | | flux | Presence | paniculate | | Cycle | mal- |
| | | concentration | Viscosity | density | of the | metals | Storage | character- | function |
| Table 2 | Binder | (wt %) | (mPa · s) | (gauss) | prefilter | (ppm) | stability | istic | ratio |
| Example 1 | Binder composition 1 | 50 | 14.0 | 8000 | Present | 0.1 | A | A | A |
| Example 2 | Binder composition 2 | 50 | 14.0 | 2000 | Present | 0.5 | B | B | B |
| Example 3 | Binder composition 3 | 8 | 620 | 8000 | Present | 0.2 | A | A | A |
| Example 4 | Binder composition 4 | 8 | 620 | 2000 | Present | 0.6 | A | B | B |
| Example 5 | Binder composition 5 | 6 | 250 | 8000 | Present | 0.1 | A | A | A |
| Example 6 | Binder composition 6 | 6 | 250 | 2000 | Present | 0.4 | B | B | B |
| Comparative example 1 | Binder composition 7 | 50 | 14.0 | — | Present | 9.8 | D | C | D |
| Comparative example 2 | Binder composition 8 | 50 | 14.0 | — | Not present | 15.5 | D | D | D |
| Comparative example 3 | Binder composition 9 | 8 | 620 | — | Present | 8.5 | D | C | C |
| Comparative example 4 | Binder composition 10 | 8 | 620 | — | Not present | 13.8 | D | C | D |

According to the result of Table 1, followings can be understood.

According to the present invention, as shown in the examples 1 to 6, when the binder compositions obtained by the step of removing the particulate metal included in the polymer dispersion solution is used, the slurry for the electrode having superior storage stability can be obtained, and by using this slurry for the electrode, the secondary battery having superior cycle characteristics, and having low malfunction ratio can be obtained. Among these, those filtered by the magnetic filter having the magnetic flux density of 8000 gauss (the example 1, 3 and 5) are particularly superior in the storage stability of the slurry for the electrode, has superior cycle characteristic, and has low malfunction ratio.

On the other hand, when the binder composition obtained without removing the particulate metal included in the polymer dispersion solution is used, the storage stability of the slurry for the electrode obtained by using this is deteriorated, and the cycle characteristics of the secondary battery obtained by using this slurry for the electrode is deteriorated thus the malfunction rate is increased.

1. A method of production of a binder composition for a secondary battery comprising a polymer and a dispersing medium; wherein said method of production includes a step of removing a particulate metal component included in a polymer dispersion including the polymer and the dispersion medium.

2. The method of production of the binder composition as set forth in claim 1, wherein said step of removing the particulate metal component is carried out by a magnetic force.

3. A binder composition for the secondary battery obtained by the method of production as set forth in claim 1 or 2 wherein the content of the particulate metal component having the particle diameter of 20 μm or more is 10 ppm or less.

4. The binder composition for the secondary battery as set forth in claim 3 wherein said particulate metal component is constituted by at least one metal selected from the group consisting of Fe, Ni, and Cr.

5. A slurry for the secondary battery electrode comprising the binder composition obtained by the method of production as set forth in claim 1 or 2, and an electrode active material.

6. A secondary battery electrode formed by coating the slurry for the secondary battery electrode as set forth in said claim 5 to a current collector and drying.

7. A secondary battery including a positive electrode, a negative electrode, and a current collector; wherein at least one of the positive electrode and the negative electrode is the secondary battery electrode as set forth in claim 6.
